(19) United States
(12) Patent Application Publication
(10) Pub. No.: US 2026/0332765 A1
(43) Pub. Date: Oct. 22, 2026

(54) UNIFORM VECTOR QUANTIZATION FOR END-TO-END IMAGE/VIDEO COMPRESSION

(71) Applicant: InterDigital CE Patent Holdings, SAS, Paris (FR)

(72) Inventors: Muhammet BALCILAR, Cesson-Sevigne (FR); Karam NASER, Cesson-Sevigne (FR); Franck GALPIN, Cesson-Sevigne (FR); Pierre HELLIER, Thorigne-Fouillard (FR)

(21) Appl. No.: 19/110,338

(22) PCT Filed: Sep. 19, 2023
(86) PCT No.: PCT/EP2023/075835

§ 371 Date: Mar. 10, 2025

(30) Foreign Application Priority Data
Sep. 27, 2022 (EP) 22306427.0

(51) Int. Cl. H04N 19/124; H04N 19/119; H04N 19/42

(52) U.S. Cl. CPC H04N 19/124; H04N 19/119; H04N 19/42

(57) ABSTRACT

In end-to-end compression, a deep neural network based encoder can be used to encode an image. The embeddings output from the encoder are quantized and encoded with a lossless encoder. In one implementation, we propose to apply uniform VQ (Vector Quantization) to the embeddings which were trained/optimized for uniform SQ (Scalar Quantization). In addition, we propose to take the existing model and finetune a part of the model or the full model with respect to the new fixed optimal VQ map. In this way, the decoder becomes more stable for high individual quantization errors. Since the encoder may be trained based on SQ and the deployment is based on VQ, we also refer to our method as a hybrid SQ/VQ method.

### TECHNICAL FIELD

The present embodiments generally relate to a method and an apparatus for end-to-end neural compression of images and videos.

### BACKGROUND

End-to-end compression is a compression technique where all components of the processes are learned from given data. End-to-end means that everything is learned from one end (given data) to another end (compressed bitstream). Once the architecture is defined for end-to-end compression, there is no manual engineering work on designing the steps. End-to-end neural compression methods are not standardized yet. Currently MPEG is exploring these technologies.

### SUMMARY

According to an embodiment, a method of video encoding is presented, comprising: obtaining latents associated with image data using a neural network; performing uniform vector quantization on said latents to obtain respective codewords; and performing lossless encoding on indices of said respective codewords based on a probability distribution of said latents.

According to another embodiment, a method of video decoding is presented, comprising: performing lossless decoding to obtain codeword indices based on a probability distribution of latents representing image data; performing uniform vector de-quantization based on said codeword indices to reconstruct latents associated with said image data; and decoding said image data from said reconstructed latents using a neural network.

According to another embodiment, an apparatus for video encoding is provided, comprising one or more processors and at least one memory coupled to said one or more processors, wherein said one or more processors are configured to: obtain latents associated with image data using a neural network; perform uniform vector quantization on said latents to obtain respective codewords; and perform lossless encoding on indices of said respective codewords based on a probability distribution of said latents.

According to another embodiment, an apparatus for video decoding is provided, comprising one or more processors and at least one memory coupled to said one or more processors, wherein said one or more processors are configured to: perform lossless decoding to obtain codeword indices based on a probability distribution of latents representing image data; perform uniform vector de-quantization based on said codeword indices to reconstruct latents associated with said image data; and decode said image data from said reconstructed latents using a neural network.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for video encoding or decoding according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a training loop of an end-to-end image compression model.

FIG. 3 illustrates an encoding process of an end-to-end image compression model.

FIG. 4 illustrates a decoding process of an end-to-end image compression model.

FIG. 5 illustrates how the current end-to-end image compression model applies quantization, dequantization, encoding and decoding with the given latents and probability in the test phase.

FIG. 6 illustrates sample unit grids in 2D space and some properties.

FIG. 7 illustrates a quantization grid for pseudo 2D latents in the default model (uniform SQ) and in our proposal (uniform VQ).

FIG. 8 illustrates how our proposal applies quantization, dequantization, encoding and decoding with the given latents and probability in the test phase, according to an embodiment.

FIG. 9A illustrates the quantization error for the 2D hexagonal grid, where latents can be anywhere inside the grid; FIG. 9B illustrates a latent and the distribution of continuous relaxation of its hexagonal grid quantization.

FIG. 10 illustrates a post-training loop of a deep decoder network for VQ grids, according to an embodiment.

FIG. 11 illustrates a post-training loop of a full model for VQ grids, according to an embodiment.

FIG. 12 illustrates BD-rate gains on the Kodak test set for different quality.

### DETAILED DESCRIPTION

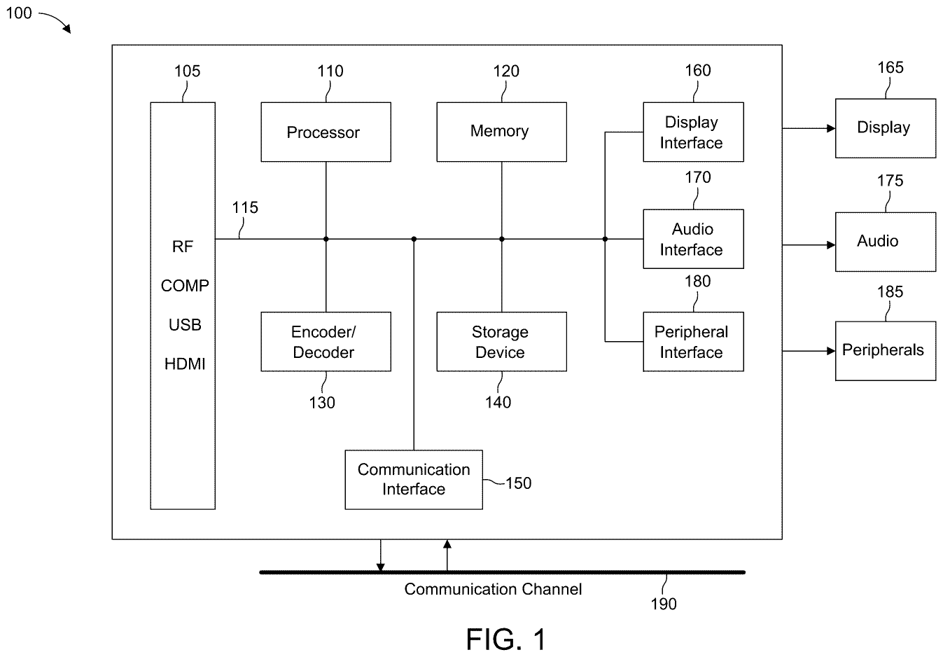

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, MPEG-4, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

### Training Phase

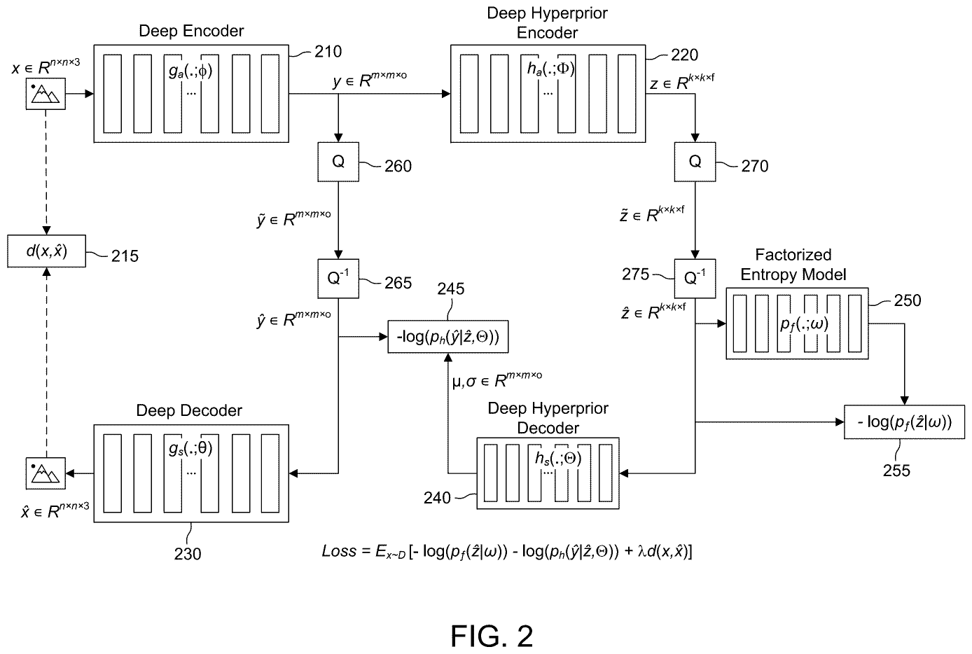

FIG. 2 illustrates the training phase of a modern end-to-end compression system. An input image to be compressed, x∈R^{n×n×3}, is first processed by a deep encoder (210) with y=gₐ(x;φ), where φ is a trainable parameter of function gₐ to be optimized during the training phase. The output of the encoder, y∈R^{m×m×o}, is called the main embedding (or main latents) of the image. Here without loss of generality, we assume the image is square (n×n) and the main embedding is also square (m×m). However, they do not need to be square and can be in any shape. The input image can be fed to the encoder at the image level or be partitioned into image regions with the individual image region as input to the encoder.

Then y goes to the quantizer (260) as \tilde{y}=Q(y) to obtain main codes of the image, followed by dequantization block ŷ=Q⁻¹(\tilde{y}) (265) to obtain reconstructed main latents ŷ. State of the art neural models use the hyperprior entropy model. In particular, the side embedding (or side latents) z∈R^{k×k×f} is learned by another deep neural network (220) by z=hₐ(y;Φ), where Φ is a trainable parameters of function hₐ to be optimized during the training phase, and the side embedding is quantized (270) by \tilde{z}=Q(z) to obtain side codes \tilde{z}, followed by dequantization \hat{z}=Q⁻¹(\tilde{z}) (275) to obtain reconstructed side latents \hat{z}. These \hat{z} are used to learn the probability model of ŷ. Typically, ŷ can be modelled by Gaussian distribution where the parameters are obtained by another deep network (240) such as [μ,σ]=hₛ(\hat{z};Θ). The decompressed image \hat{x}∈R^{n×n×3} is obtained by a deep decoder (230) with \hat{x}=gₛ(ŷ;θ).

The values of m and k depend on the defined architecture, and m usually is 1/16 of the image's spatial resolution, and k is usually ⅛ of the embedding's size. The value of o is fixed at 128 for instance in most common architectures. In one example, if the image size is 256×256×3, usually y will be 16×16×128 and z will be 2×2×128.

In this model, the lower bound of bitlength of side codes \tilde{z} is calculated by the factorized entropy model (250). This model accepts \hat{z} as input and learns the probability density function (PDF) of the side codes \tilde{z}. Using this PDF, the model calculates the probability mass function (PMF) of each code under a certain quantization method. PMF values are enough to calculate the lower bound of the bitlength of side codes. On the other hand, the lower bound of the bitlength of main codes y is calculated by the hyperprior entropy model. This model is usually implemented by Gaussian distribution. Basically, each reconstructed main latent (ŷᵢ) in ŷ is supposed to follow Gaussian distribution where the parameters (μᵢ, σᵢ) are obtained by side information in the previous step. Thus, these Gaussian's PMF under the determined quantization method is enough to calculate the lower bound of the bitlength of main codes.

In this setting, the deep encoder (gₐ(.;φ)), deep decoder (gₛ(.;θ)), deep hyperprior encoder (hₐ(.;Φ)), deep hyperprior decoder (hₛ(.;Θ)) and factorized entropy model p_{f}(.;ω) are composed of multiple neural layers, such as convolutional layers. Each neural layer can be described as a function that first multiplies the input by a tensor, adds a vector called the bias and then applies a nonlinear function on the resulting values. The shape (and other characteristics) of the tensor and the type of non-linear functions are called the architecture of the network. We will denote the values of the tensor and the bias by the term “weights”. The weights and, if applicable, the parameters of the non-linear functions, are called the parameters. The architecture and the parameters define a “model”. As described above, we denote their parameters by φ, θ, Φ, Θ and ω.

Many end-to-end architectures have been proposed recently. Typically, they are more complex than what is illustrated in FIG. 2, but they all retain the deep encoder and decoder. State of the art models can compete with traditional codecs in terms of rate distortion tradeoffs.

A model must be trained on massive databases D of images to learn the weights of the encoder, decoder and entropy models. Typically, the weights are optimized to minimize a training loss:

Loss=E_{x~D}[−log(p_{f}(\hat{z}|ω))−log(pₕ(ŷ|\hat{z},Θ))+λd(x,\hat{x})], (1)

where d(.,.) (215) is a measure of the distortion between the original and the reconstructed image (for example the mean square error). The rate term (255, 245) is the sum of the lower bound of the bitlength of side information (−log(p_{f}(\hat{z}|ω))) and the lower bound of the bitlength of main information (−log(pₕ(ŷ|\hat{z},Θ))). Hyperparameter A controls the trade-off between the rate (r) and distortion (d) terms. Note here the rate is based on the lower bound of the bitlength of main information and side information, but other methods can be used to estimate the rates.

### Deployment (Test) Phase

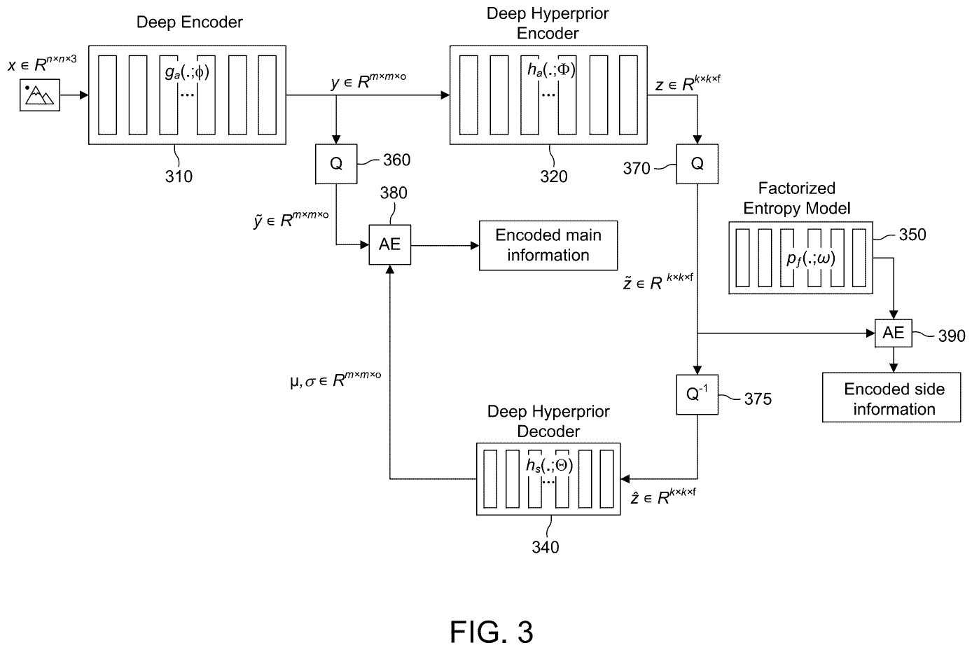

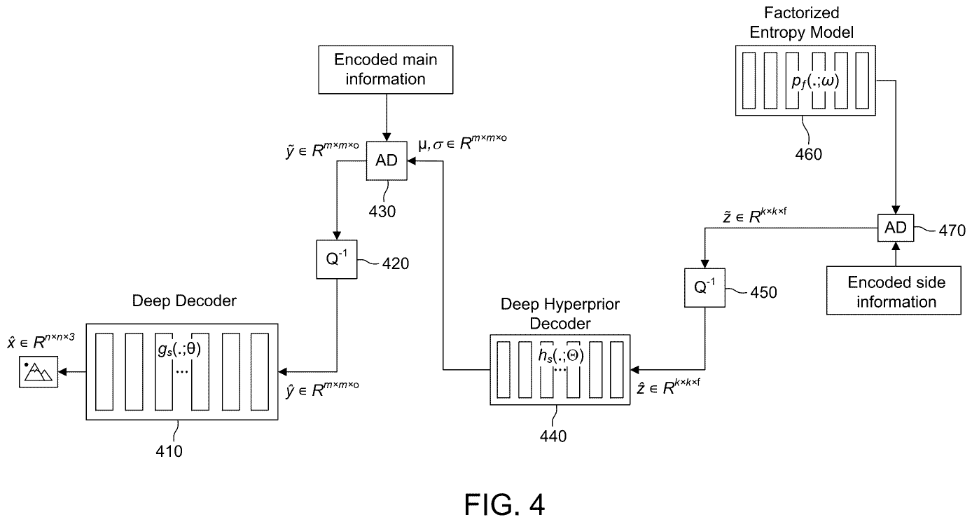

When this model is trained and the optimal parameters (φ, θ, ω, Φ, Θ) are obtained, we can deploy the model in encoding and decoding devices as illustrated in FIG. 3 and in FIG. 4, respectively. This phase is usually called test phase. In the test phase, both encoding and decoding devices need PMF tables. Besides the PMF table, encoding and decoding devices must agree on which quantization method is used as well.

As illustrated in FIG. 3, in the encoding device, main codes and side codes are obtained (310, 320) from a given image by the same way as in the training phase. Later, the encoding device converts the side codes into a bitstream by a lossless encoder, for example, an arithmetic encoder AE (390) driven by the learned PMF tables provided by the factorized entropy model (350). Side codes obtained from quantization (370) are dequantized (375) and reconstructed side latents are obtained in the next step. A hyperprior entropy decoder (340) decodes reconstructed side latents in order to find the distribution of main codes. Finally main codes obtained from quantization (360) are converted into bitstream by a lossless encoder, for example, an arithmetic encoder AE (380) using these distributions. Finally, these two bitstreams are concatenated with some pointer in between.

As illustrated in FIG. 4, in the decoding device, the process starts with decoding of side codes from the bitstream, which can be done by a lossless decoder, for example, an arithmetic decoder AD (470) by using the learned PMF tables provided by the factorized entropy model (460). The side codes are dequantized (450) and reconstructed side latents are obtained in the next step. A hyperprior entropy decoder (440) accepts reconstructed side latents as input in order to find the distribution of the main codes. These distributions inform the AD (430) how to read the main codes from the bitstream. Dequantization (420) is then applied on the main codes to reconstruct the main latents. The decoding device can get the reconstructed image by feeding the deep decoder (410) with the reconstructed main latents.

### Quantization

The quantization step denoted as Q(.) and its counterpart dequantization step Q⁻¹(.), need to be applied to obtain the reconstructed main and side latents. For the simplicity, we provide explanation on main latents. The same quantization and dequantization can be applied to the side latents as well.

In the end-to-end compression literature, quantization was applied in two different classes of approaches either by Scalar Quantization (SQ) or Vector Quantization (VQ). SQ assigns a code for each scalar (y_{i,j,c}) in the embedding tensor (y) separately while VQ first constructs v-dimensional vectors

$$\check{y} ∈ {R}^{v \times ( m . m . \frac{o}{v} )}$$

from y∈R^{m×m×o} and assigns a code for each v-dimensional latent y̌ᵢ∈R^{v}. Thus, the number of codes in VQ is v times less than the number of codes in SQ. However, the number of distinct values in the codebook (dictionary length) of VQ should be higher than SQ, thus the probability of each code in VQ will be much lower than the probability of codes in SQ. It results in the same rate and distortion performance if the SQ's quantization border is used in all VQ's dimensions. The quantization border is the boundary between the quantization grids (partition regions) of the quantization map. For example, for scalar quantization, if the number in range [1.5, 2.5] is quantized into 2, then this quantization bin's borders are 1.5 and 2.5. In the VQ case, the data has higher dimension.

However, VQ may not apply the same quantization border for each dimension. It may find a better quantization grid on the higher dimensional space, thus increasing the rate distortion performance.

Regardless of the selected quantization technique, the quantization step is not directly usable in gradient-based training since the quantization has non-informative gradients (zero almost everywhere, infinity on quantization border). One approach is to use continuous relaxation of uniform SQ. In this solution, quantization is simulated by Q(x)=x+ϵ, where ϵ is a random sample from uniform noise with 1-bin width around the zero point such as ϵ~U(−0.5,0.5) in the training phase, where U(−0.5,0.5) represents uniform distribution that generates random number between −0.5 to 0.5. But in the test phase, the deterministic hard quantization is applied. For instance, in the case of 1-bin width uniform SQ, it applies nearest integer rounding as Q(x)=round(x) in the test phase. In this approach, there are no trainable parameters in the quantization step and dequantization step is the identity function as Q⁻¹(x)=x. Since the encoder network can apply non-linear transformation, it is expressive enough to shrink and/or expand the embedding values, thus, optimizing the model with uniform fixed bin-width quantization (1 bin width) seems reasonable.

In the VQ case, the codewords (quantization centers) of the predefined number of quantization grids (Cⱼ∈R^{v}, j=1 . . . M) usually are learned jointly with the rest of the parameters of the model. In this document, we use the terms “codeword” and “quantization center” interchangeably, both referring to the representative point of a quantization grid in vector quantization. In the test phase, each v-dimensional embedding should be assigned to the index of the closest quantization center as

$$Q ( {\check{y}}_{i} ) = {arg min}_{j ∈ \vert M \vert} {‖ {\check{y}}_{i} - {C}_{j} ‖}^{2}$$

and return the quantization center coordinate for the dequantization step as Q⁻¹(j)=Cⱼ. Since the argmin operator applies hard assignment (assign the closest quantization center's index), it is not differentiable. In the training phase, soft assignment was used. Soft assignment assigns all M codes in the dictionary to y̌ᵢ with different probabilities according to their distances. Thus, its dequantization is the weighted sum of all quantization centers where the weights are calculated by probabilities according to their distances.

### Suboptimality of Quantization

Both quantization approaches have some advantages and disadvantages. On one hand, SQ is quite consistent in the training phase and has low computational complexity. But it is provable that SQ is not an optimal quantizer, even though the embeddings are supposed to be independent and identical distributed values (i.i.d., no correlations between codes). SQ is not optimal among even uniform quantization as well. It is theoretically known that, when we use infinitely high dimensional VQ, we can reach the theoretical limit of rate-distortion performance. On the other hand, learning VQ quantization is unstable in the end-to-end manner, and it is hard to learn a better quantization map (a collection of quantization grids that fill the space without a gap) than SQ. Besides, VQ learns non-uniform quantization maps and it is not clear if we need non-uniform quantization maps because the deep encoder can learn any non-linear transformation that transform a non-uniform quantization map into a uniform quantization map. Thus, uniform quantization grids may be enough, and they can be learned more robustly. So far, most current end-to-end image compression methods use the uniform SQ quantizer and do not use the theoretical advantage of VQ.

Although VQ is theoretically better than SQ, the current modern end-to-end compression method does not use this advantage. Optimizing the model with uniform SQ is reported to be the most empirical solution so far in the literature. It may be because of difficulties in optimizing the quantization center in the higher dimension jointly with the rest of the model parameters and double necessity of finding the non-uniform quantization grid as it is default in VQ. In this document, we apply the theoretically powerful VQ method to the model optimized using uniform SQ.

As will be described in detail below, in the first embodiment, we take advantage of both SQ and VQ by proposing to apply uniform VQ to the embeddings which were trained/optimized for uniform SQ. This embodiment does not need any re-training phase, instead it takes any pre-trained model that is optimized for uniform SQ on the latents and changes its quantization map with the theoretically known optimal VQ grid on higher dimension. One of the drawbacks of this approach is that, even though our average quantization error is lower than the default one, some latent's individual quantization error may be higher than the maximum expected quantization error in SQ. Thus, the decoder may not be robust for this individual latent's quantization error. In average the proposed method never makes the rate distortion performance worse than the default model, but the proposal becomes clearly sub-optimal. To this end, we propose the second and third embodiments which take the existing model and finetune a part of the model or the full model with respect to the new fixed optimal VQ map. In this way, the decoder becomes more stable for these high individual quantization errors. Since the encoder may be trained based on SQ and the deployment is based on VQ, we also refer to our method as a hybrid SQ/VQ method. According to our test, we improved the BD-rate of the state-of-the-art end-to-end compression algorithm by more than 2%.

Most recent end-to-end image/video compression models encode two kinds of information, namely, main codes (\tilde{y}) and side codes (\tilde{z}) into the bitstream. According to our analysis, the vast majority of the bitstream is used by the main codes (around 95-99%) and a fraction of the bitstream is used by the side codes. That is why the improvement on main codes encoding is much more important than side codes. However, our methods can be applied to both types of codes.

### Definitions

Without loss of generality, we assume there is one kind of latents named y∈R^{m×m×o} and we have s PDF p^{(c)}: R→R, c=1 . . . s, learned by an entropy model under fixed bin width uniform SQ. For simplicity, we can assume quantization bin-width is 1. We also know which latent in m×m×o sized tensor corresponds to which PDF out of s. We can refer to this information by s sets [symbol] _{c}, c=1 . . . s, each set shows the indices of m×m×o sized tensor. For instance, [symbol] ₁ shows the latent's indices whose corresponding PDF is p⁽¹⁾. Thus, the total number of indices in each set must be equal to the total number of latents in y, i.e.,

$$m . m . o = {\sum }_{c = 1}^{s} \vert {𝒩}_{c} \vert$$

(the number of total elements in c-th set is | [symbol] _{c}|). We can define a new vector by y^{(c)}∈ [symbol] : [yᵢ|i∈ [symbol] _{c}]^{T} which shows the latents that correspond to the same PDF p^{(c)}. Each y^{(c)} can be seen as a subset of embedding y that makes y=y⁽¹⁾∪y⁽²⁾∪ . . . ∪y^{(s)}. For side information, which latent uses which PDF is determined by the last index of the embeddings (feature band refers corresponding PDF) that shows the position out of f positions. For example, if z has a 4×4×128 dimension, then z(2,1,46) shows a scalar in the 2^{nd} row, 1^{st} column and 46^{th} feature band and the last index is 46. For main codes, this information is obtained by the entropy model using side information.

### State of the Art Methodology

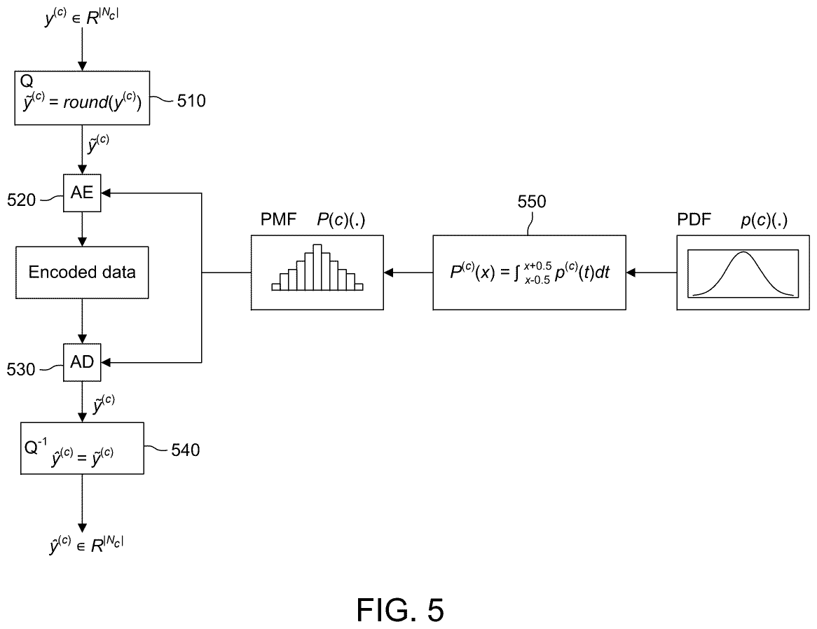

Currently, as shown in FIG. 5, most end-to-end compression methods take (y^{(c)}∈ [symbol] , p^{(c)}: R→R) pairs as input and quantize (510) the latent according to 1 bin-width uniform SQ as \tilde{y}^{(c)}=round(y^{(c)}) in the deployment phase. The PMF table is also calculated (550) for the quantization center x (integer center) by

$${P}^{( c )} ( x ) = {\int }_{x - 0.5}^{x + 0.5} {p}^{( c )} ( t ) dt .$$

Later, codes \tilde{y}^{(c)} can be converted to the bitstream by AE (520) with PMF table P^{(c)}(.). In this way, the expected bitlength would be

$${\sum }_{j = 1}^{\vert {𝒩}_{c} \vert} log ( {P}^{( c )} ( {\hat{y}}_{j}^{( c )} ) ) .$$

This process should be repeated for all c=1 . . . s. Thus, the final expected bitlength (rate) would be

$$R = {\sum }_{c = 1}^{s} {\sum }_{j = 1}^{\vert {𝒩}_{c} \vert} log ( {P}^{( c )} ( {\hat{y}}_{j}^{( c )} ) ) .$$

The PMF table P^{(c)}(.) is also used by AD (530). Since the dequantization step (540) of nearest integer quantization is an identity function, the dequantized latents are the same with codes as it is ŷ^{(c)}=\tilde{y}^{(c)}. Because quantization is not invertible function, there is some error between given latent y^{(c)} and reconstructed latent ŷ^{(c)} that defines quantization error

$$D = {\sum }_{c = 1}^{s} {‖ {y}^{( c )} - {\hat{y}}^{( c )} ‖}^{2} .$$

This error can be seen as an approximation of error of reconstructed image.

### Proposed Methods

Even though the given latents in the vector y^{(c)} are i.i.d. and there is no known redundancy between latents, theoretically VQ can reach better rate-distortion performance than SQ. In our methods, we prevent VQ from learning a non-uniform quantization grid but stick with a uniform quantization grid. We select the uniform quantization grid because of the doubt on the necessity of a non-uniform quantization map in end-to-end compression. We believe that the encoder network is expressive enough to produce necessary transformation. The encoder network can expand or shrink necessary latent values before quantization. Thus, quantization can be applied by the uniform quantization grid. Another reason is that in our first embodiment, we do not re-train the model which is pre-trained for the uniform quantization grid. To avoid mismatches, we stay with the uniform quantization grid. Since the encoder will have the ability to scale the latent (e.g., multiply them with a scalar), learning the quantization bin-width for a certain rate-distortion tradeoff (certain A in the loss function) will be meaningless as well. Thus, selection of the quantization bin-width is arbitrary, and we can use the selection in the literature, for example, 1. Our main motivation is to decrease the quantization error of latent by applying VQ with the optimal uniform quantization grid while keeping the rate in the same level (or almost in the same level) as that of the trained scalar quantization.

We believe our methods have at least the following novelties.
Limiting the VQ to apply a uniform quantization map is new. So far in the literature, VQ based end-to-end compression models learn the quantization grid jointly with model parameters and all find non-uniform quantization grids which we believe, are not necessary and hurt the optimization. Since the optimal uniform VQ quantization grids for a certain bin-width are known theoretically, we do not need to learn these quantization centers.
Decreasing the quantization error of the uniform SQ based trained model by re-arranging the quantization centers and PMF tables with the optimal uniform VQ grid is new. This is our first embodiment and can be seen as post processing upon any uniform SQ based trained model.
Finetuning the SQ based model to be able to adapt the optimal uniform VQ quantization grid as in our second and third embodiments are new as well. These embodiments can be seen as post finetuning upon our first embodiment.

### First Embodiment—Optimal Uniform VQ as Post Processing

It is known that we can approach the theoretical rate-distortion limit when VQ is applied for an increasing dimension. Thus, we can reach the limit when VQ is applied for an infinite dimension. But in practice a small dimensional VQ already provides stronger result than SQ. Since the latents to be quantized in the end-to-end compression model are learned for uniform quantization grids because of the advantages mentioned above, we need to determine optimal centers under the constraint that the quantization grid should be uniform. As explained in the following, this constraint helps us get rid of applying the time-consuming iterative Lloyd algorithm or the non-stable quantization center learning process jointly with the rest of the model parameters.

Among the uniform quantizer in v-dimension, uniform VQ is optimal. If the v-dimensional space is filled without any blank area and without overlapping with a repetition of a single v-dimensional shape that has minimum surface/volume ratio (minimum energy), the optimal VQ solution is equivalent to this uniform v-dimensional shape partitioning.

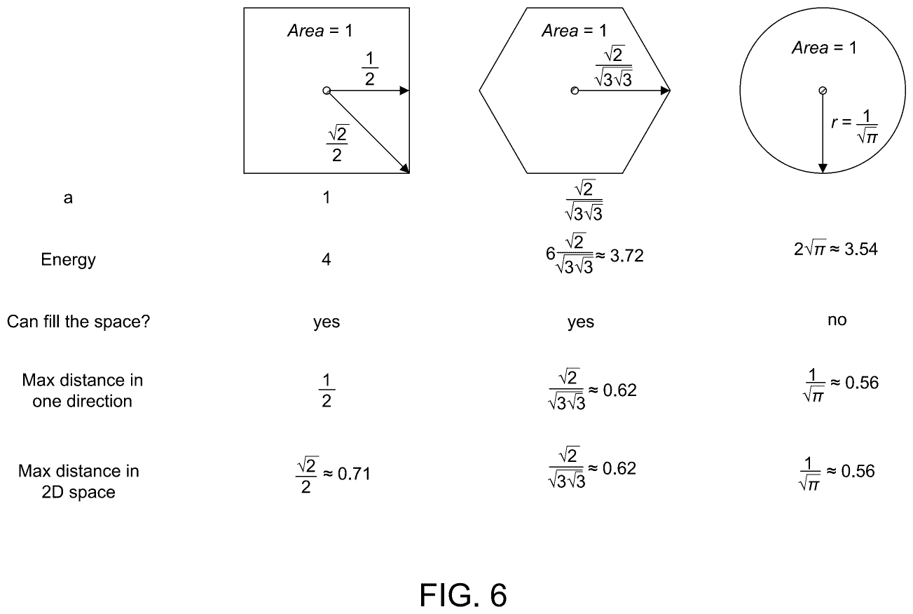

In 2D space, the square grid can fill the space well. However, a unit area square grid's energy (circumference/area) is 4. A circle that has unit area has the minimum energy with 2\sqrt{π}/≈3.54, but it cannot fill the 2D space without blank and overlapping. However, a hexagonal grid can fill the space well and has energy approximately 3.72 which is better than a square grid. These examples can be seen in FIG. 6. A hexagonal grid is known as the optimal uniform quantization grid in 2D space. Thus, in 2D VQ, we can tile the space with M hexagonal grids whose centers are initially calculated as Cⱼ∈R², j=1 . . . M.

In the 3D space, the truncated octahedron is to be known as the best candidate for the uniform quantization grid. For 3D VQ, the best selection would be M truncated octahedron that tiles the 3D space where their centers are Cⱼ∈R³, j=1 . . . M. Our methods are not limited to 2D and 3D optimal uniform quantization centers. Besides, it can accept any initially calculated v-dimensional quantization center Cⱼ∈R^{v}, j=1 . . . M. Since we can see SQ as a special kind of VQ where it applies square grids in all dimensions, any initial calculated uniform grid that has less energy than the square grid will improve the quantization error of the latents.

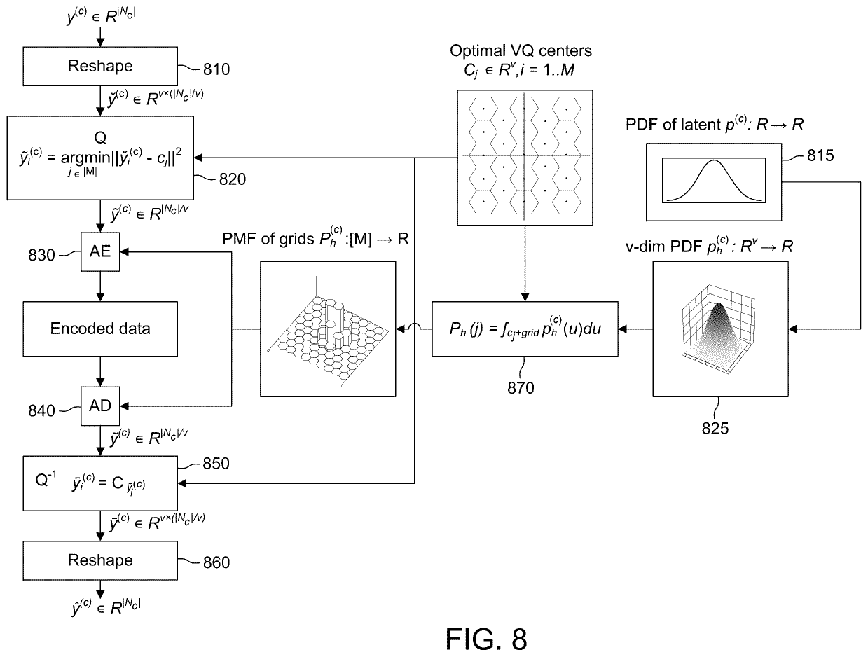

FIG. 8 illustrates a method to be applied in the test phase, according to an embodiment. The encoder can decide the value of v. For example, the encoder may take a fixed value, v=2 or 3. The encoder can also test different values, for instance v=2, 3, 4, 5, then uses the best option and writes the value of v into the bitstream as extra information. After determining v, the uniform grid located on zero reference point grid and all grids' centers Cⱼ∈R^{v}, j=1 . . . M, we need to create pseudo v-dimensional vectors from y^{(c)}∈ [symbol] . Since all scalars in y^{(c)} are i.i.d., we can reshape (810) y^{(c)} in any order, even a random order. Since this order should be known by the decoder device, we select to reshape the vector, for example, in a raster order, into y̌^{(c)}∈ [symbol] . If the length of the vector cannot be partitioned into v group, we can use zero padding to fill the missing part. Now each column vector of reshaped latents is a point in the v-dimensional space as

$${\check{y}}_{i}^{( c )} ∈ {R}^{v}$$

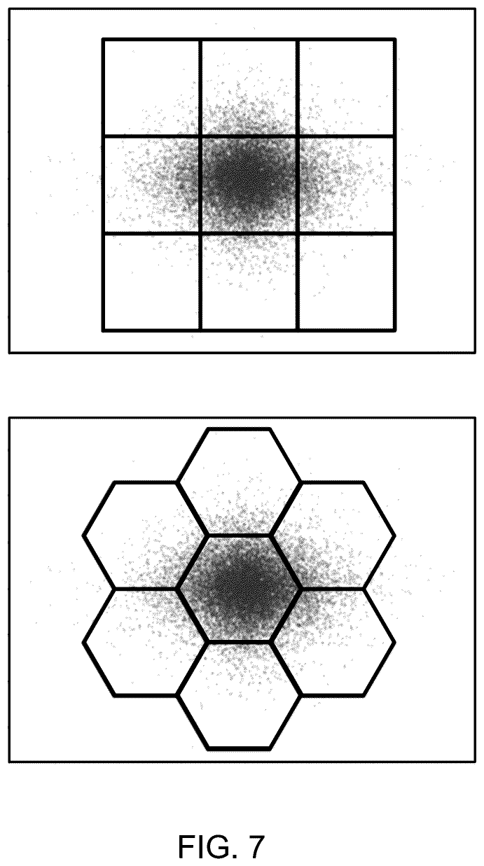

and there are | [symbol] _{c}|/v v-dimensional points to be assigned respective codes. As an example, these pseudo 2-dimensional latents can be seen in FIG. 7 with the quantizing unit square grid as in the default SQ model and the hexagonal grid for a special case, where v=2.

In the quantization step (820), we find the index of the closest quantization center for each

$${\check{y}}_{i}^{( c )} ,$$

i=1 . . . | [symbol] _{c}|/v. This step can be obtained by

$${\tilde{y}}_{i}^{( c )} = {arg min}_{j ∈ \vert M \vert} {‖ {\check{y}}_{i}^{( c )} - {C}_{j} ‖}^{2} .$$

Now we have codes \tilde{y}^{(c)}∈ [symbol] that represents the indices of quantization centers.

To encode these codes into the bitstream, AE (830) needs the PMF of each distinct code where the default PMF shows probability of each integer scalar. In order to obtain necessary PMF values, first we create a v-dimensional PDF (825) by using the PDF (815) provided by entropy model p^{(c)}: R→R. Since both axes follow the same PDF p^{(c)}(.), we obtain PDF by

$${p}_{h}^{( c )} ( u ) = {\prod }_{i = 1}^{v} {p}^{( c )} ( {u}_{i} ) ,$$

where u∈R^{v}. Later, we can discretize

$${p}_{h}^{( c )} ( u )$$

for quantization centers by integrating (870) all probabilities inside the quantization grids as

$${P}_{h}^{( c )} ( j ) = {\int }_{{C}_{j} + grid} {p}_{h}^{( c )} ( u ) du$$

in order to have the PMF of grids

$${P}_{h}^{( c )} : [ M ] \to R .$$

Here j iterates all quantization centers j=1 . . . M, where Cⱼ+grid represents the j-th quantization grid centered on Cⱼ. In the 2D case it is the hexagonal grid. This integral can be calculated analytically. However, for more complex grids, Monte-Carlo simulations can be useful. We can generate millions of v-dimensional data points where the dimensions are i.i.d. and each follows p^{(c)}(.). Then we can count how many points fall in each grid and have the frequency of each grid. The normalized frequencies will give quite a good approximate PMF of grids. AE can encode \tilde{y}^{(c)} by using

$${P}_{h}^{( c )} ( \cdot ) .$$

As also illustrated in FIG. 8, the decoder device also needs initially calculated

$${P}_{h}^{( c )} ( . )$$

to obtain codes \tilde{y}^{(c)} by an arithmetic decoder AD (840) from the bitstream. This step should be followed by the de-quantization step (850) which returns the quantization center of the corresponding quantization grid shown by reconstructed codes

$${\overline{y}}_{i}^{( c )} = {C}_{{\tilde{y}}_{i}^{( c )}} .$$

Then, we need to cancel out the reshaping process at the beginning of the encoding by reshaping (860) y̅^{(c)}∈ [symbol] into ŷ^{(c)}∈ [symbol] .

In the following, we show the step-by-step processes in three-folds, first the steps that should be executed offline (before deployment), later the steps that should be done after deployment in the encoding device and last the steps that should be done after deployment in the decoding device.

### Steps to be Done Before Deployment:

Step1. Define v, grid and optimal uniform quantization centers Cⱼ∈R^{v}, j=1 . . . M. As described above, in our embodiment, the quantization centers for the uniform VQ are known (e.g., for v=2 or 3, the quantization center of a grid is the geometric center of the corresponding grid).
Step2. For all c=1 . . . s
   Calculate the PMF of quantization centers

$${P}_{h}^{( c )} ( . ) ,$$

by using default PDF p^{(c)}(.).
Step3. Share v, grid, Cⱼ∈R^{v}, j=1 . . . M, and

$${P}_{h}^{( c )} ( . )$$

c=1 . . . s with both encoding and decoding devices.

### Steps to be Done in the Encoding Device:

Step1. Input image x∈R^{n×n×3}.
Step2. Obtain embeddings y∈R^{m×m×o} by the deep encoder network.
Step3. Obtain PMF correspondence set [symbol] _{c}, c=1 . . . s ( [symbol] _{c} is fixed for side information, and can be obtained from side information for main information with following Steps 3.1-3.5).
   Step3.1 Obtain embeddings z∈R^{k×k×f} by the deep encoder network by z=hₐ(y;Φ).
   Step3.2 Obtain reconstructed side latent codes \hat{z}=Q⁻¹(Q(z)).
   Step3.3 Obtain the distribution parameter of main latents [μ, σ]=hₛ(\hat{z}; Θ), where μ, σ∈R^{m×m×o}.
   Step3.4 Classify each scalar yᵢⱼₖ with its corresponding scalar σᵢⱼₖ into s group. If the σ^{(b-1)}≤σᵢⱼₖ<σ^{(b)}, yᵢⱼₖ is classified in the b-th group. There are s+1 predefined classes [0, σ⁽¹⁾, . . . , σ^{(s)}], and each yᵢⱼₖ is assigned a group out of s.
   Step3.5 Create a set [symbol] _{c} that keeps the indices of yᵢⱼₖ which is assigned to the c-th group.
Step4. Divide latents into subsets y^{(c)}∈ [symbol] : [yᵢ|i∈ [symbol] _{c}]^{T}, c=1 . . . s w.r.t. corresponding PMF correspondence.
Step5. For all c=1 . . . s
   Step5.1 Reshape y^{(c)}∈ [symbol] into y̌^{(c)}∈ [symbol] ;
   Step5.2 Apply VQ by

$${\tilde{y}}_{i}^{( c )} = {arg min}_{j ∈ \vert M \vert} {‖ {\check{y}}_{i}^{( c )} - {C}_{j} ‖}^{2} for i = 1 … \vert {𝒩}_{c} \vert / v ;$$

Step5.3 Encode \tilde{y}^{(c)} into the bitstream by AE using

$${P}_{h}^{( c )} ( . ) .$$

Step6. Return the bitstream.

### Steps to be Done in the Decoding Device:

Step1. Input the bitstream.
Step2. For all c=1 . . . s
   Step2.1 Read codes \tilde{y}^{(c)} from the bitstream by AD using

$${P}_{h}^{( c )} ( . ) ;$$

Step2.2 Dequantize codes by

$${\overline{y}}_{i}^{( c )} = {C}_{{\tilde{y}}_{i}^{( c )}} ;$$

Step2.3 Reshape y̅^{(c)}∈ [symbol] into ŷ^{(c)}∈ [symbol] .
Step3. Obtain PMF correspondence set [symbol] _{c}, c=1 . . . s ( [symbol] _{c} is fixed for side information and can be obtained from side information for main information).
Step4. Unite subsets of latents

$$\hat{y} = {⋃}_{c = 1}^{s} ( {\hat{y}}^{( c )} , {𝒩}_{c} )$$

where ŷ∈R^{m×m×o}.
Step5. Obtain reconstructed image \hat{x}∈R^{n×n×3} by the deep decoder network.

### Post Training for New Quantization Grids

One of the drawbacks of the first embodiment is the higher individual maximum quantization error in VQ than SQ. This issue is shown in FIG. 6 for 2D case. Even though the average quantization error in a hexagonal grid (the optimal uniform VQ in 2D) is less than SQ, the maximum absolute quantization error in one dimension can be larger than the SQ case. As shown in FIG. 6, the maximum distance from a single latent (on one dimension) to the quantization center is 0.5 for the square grid (SQ). However, in a hexagonal grid (optimal uniform VQ) this distance can be approximately 0.62. In the training phase, quantization is simulated by adding uniform noise sampled between −0.5 to 0.5 as ϵ~U(−0.5, 0.5). That means, after training, the deep decoder network would be robust enough if any latent differ in range of [−0.5, 0.5] after quantization which is expected quantization error in SQ. In the following, we describe how we can simulate the new grid's quantization error in the training phase.

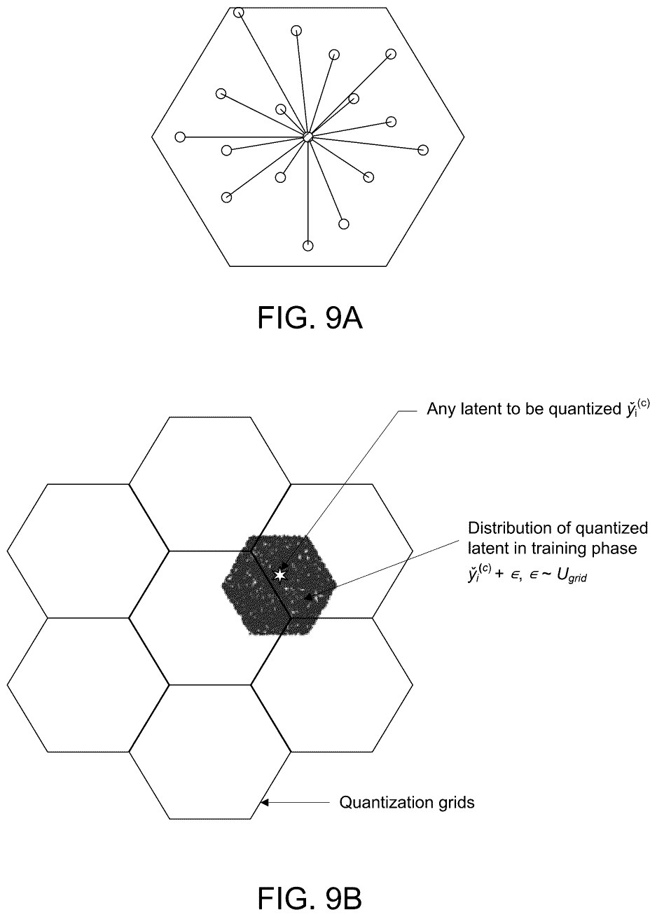

Since any v-dimensional point inside the v-dimensional gridᵢ should be quantized at the center of the grid and we do not have any prior information where the coming latent points are highly likely, in average the best prior is to assume that latents can be anywhere inside the gridᵢ with equal probability (uniform distributed). This point is illustrated in FIG. 9A for the case of optimal 2D uniform VQ (hexagonal grid). Thus, the quantization error should follow the distribution U_{grid}, where the probability is 1 inside the grid that is centered at a reference point, but 0 otherwise.

Definition: U_{grid} is a uniform distribution in the v-dimensional space defined by:

$${U}_{g r i d} ( x ) = \{ \begin{matrix}1 , & if grid ⊃ x \\ 0 , & else\end{matrix}$$

where ∫U_{grid}(x)dx=1, x∈R^{v} and grid is a v-dimensional grid centered at zero point.

We can see that U_{grid}=U(−0.5,0.5) for scalar quantization with 1 bin-width (e.g., nearest integer rounding). We can see scalar 1 bin-width quantization in the v-dimensional space as applying a unitary v-dimensional cube grid. In that case U_{grid}=U(−0.5,0.5)^{v}. For the case of 2D VQ, since the optimal grid is a unit volume hexagonal grid, any random sample from U_{grid} will be anywhere inside the unit volume hexagonal grid with equal probability. This yields to write continuous relaxation of VQ where grid is a fixed uniform grid in the v-dimensional space.

$${\tilde{y}}_{i}^{( c )} = {\check{y}}_{i}^{( c )} + ϵ , ϵ ∼ {U}_{grid} .$$

This relaxation of quantization does not assign a grid index to the code, but just some uniform noise onto the latents. Thus, during training, we do not need to make hard assignments to the codes and its de-quantization step is an identity function as it is the same with SQ by

$${\overline{y}}_{i}^{( c )} = {\tilde{y}}_{i}^{( c )} .$$

Continuous relaxation of hexagonal grid quantization is illustrated in FIG. 9B.

### Second Embodiment—Deep Decoder Post Training for VQ Grid

To adapt the deep decoder network to the new quantization grid, here we propose to finetune the deep decoder with continuous relaxation of these new quantization grids. Since the decoder network has nothing to do with entropy (bitlength), we can optimize the decoder network for the distortion loss alone. To this end, we encode the images in the dataset first and create a new dataset which consists of image x∈R^{n×n×3}, their embeddings y∈R^{m×m×o}, PMF correspondence sets [symbol] _{c}, c=1 . . . s, and the distribution of the new grid's quantization error U_{grid}. It can be done without PMF correspondence sets. But in this way, all scalars in pseudo v-dimensional latent can follow different distributions. We found creating a v-dimensional latent with the latents that come from the same probability is a better choice. However, it can be done by skipping division of latent into subsets and execute the reshaping operation on whole latents as well.

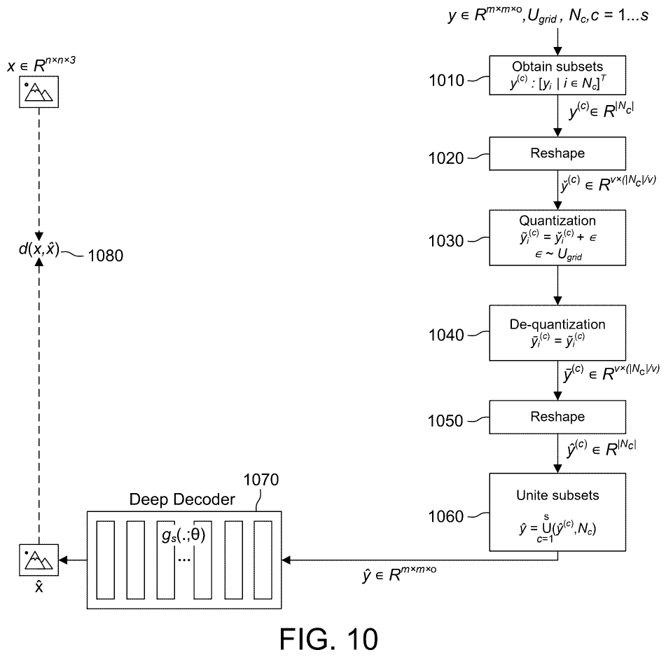

The steps of forward pass calculation of the training loop can be found below, as is also illustrated in FIG. 10. We can also apply random permutation on latents (not shown in FIG. 10) to make the position of the latent not important to create a pseudo v-dimensional vector in Step3.1. If it is the case, we should take this random permutation back in Step3.6.

### Forward Pass Steps for Deep Decoder Post Training:

Step1. Input image x∈R^{n×n×3}, embeddings y∈R^{m×m×o}, PMF correspondence sets [symbol] _{c}, c=1 . . . s, and distribution U_{grid}.
Step2. Divide latents into subsets y^{(c)}∈ [symbol] : [yᵢ|i∈ [symbol] _{c}]^{T}, c=1 . . . s w.r.t. corresponding PMF correspondence (1010).
Step3. For all c=1 . . . s
   Step3.1 (Optional) Randomly permutate the order latents of y^{(c)}.
   Step3.2 Reshape y^{(c)}∈ [symbol] into y̌^{(c)}∈ [symbol] (1020).
   Step3.3 Apply continuous relaxation of quantization

$${\tilde{y}}_{i}^{( c )} = {\check{y}}_{i}^{( c )} + ϵ , ϵ ∼ {U}_{grid} ( 1030 ) .$$

Step3.4 Apply dummy de-quantization

$${\overline{y}}_{i}^{( c )} = {\tilde{y}}_{i}^{( c )} ( 1040 ) .$$

Step3.5 Reshape y̅^{(c)}∈ [symbol] into ŷ^{(c)}∈ [symbol] (1050).
Step3.6 (if step3.1) Take back the random permutation on ŷ^{(c)}.
Step4. Unite subsets of latents

$$\hat{y} = {⋃}_{c = 1}^{s} ( {\hat{y}}^{( c )} , {𝒩}_{c} ) ,$$

where ŷ∈R^{m×m×o} (1060).
Step5. Obtain reconstructed image \hat{x}∈R^{n×n×3} by the deep decoder network (1070).

The parameter of the deep decoder network can be finetuned starting from pre-trained parameters by minimizing following loss.

$$Loss = {E}_{x , y , {𝒩}_{c} ∼ D , ∈ ∼ {U}_{grid}} [ d ( x , \hat{x} ) ] ,$$

The finetuned deep decoder network would give better performance than the first embodiment than the first embodiment alone and default model.

### Third Embodiment—Full Model Post Training for VQ Grid

Even though the decoder adapts to the new quantization grids in the second embodiment, still the bitlength (rate) was optimized for uniform SQ. In this third embodiment, we propose to optimize everything jointly for the new VQ grids.

For the side information, which latent belongs to which PDF is predefined and fixed. Therefore, we can create pseudo v-dimensional latents by using the latents that follow the same PDF p^{(c)}(.). In this way, the v-dimensional PDF can be obtained by simply multiplication of the same distribution as for 2D PDF:

$${p}_{h}^{( c )} ( x , y ) = {p}^{( c )} ( x ) \cdot {p}^{( c )} ( y ) .$$

However, in main information, each latent follows its own distribution during the training phase. They are grouped into s distributions in the test phase. Thus, each pseudo v-dimensional latent should have its own distribution. However, in the training phase, we do not need to create the pseudo v-dimensional latent whose all dimensions have the same distribution. Basically, latents in the same v-dimensional vector can follow different distributions. If we know each latent's distribution, we can create the pseudo v-dimensional PDF by simply multiplying each dimension's PDFs.

In our design, we start with reshaping embeddings of the image y∈R^{m×m×o} into a pseudo v-dimensional embedding

$$\check{y} ∈ {R}^{v \times ( m . m . \frac{o}{v} )}$$

and apply continuous relaxation of newly designed v-dimensional grid as

$${\tilde{y}}_{i} = {\check{y}}_{i} + ϵ , ϵ ∼ {U}_{grid} , i = 1 , … , m . m . \frac{o}{v}$$

followed by dequantization ŷ=\tilde{y}. Dequantized codes

$$\hat{y} ∈ {R}^{v \times ( m . m . \frac{o}{v} )}$$

are processed by entropy model in the same way as in the default model and it finds PDF of every single scalar in ŷ. These PDFs are Gaussian with parameters being calculated by entropy model and side information for main codes. For side information, these PDFs are outputs of a neural network. Without loss of generality, we can refer to PDF of each scalar ŷ_{i,j}∈R by p_{ŷ}_{_{i,j}}: R→R. Later, we can create PDF of pseudo v-dimensional vector ŷᵢ∈R^{v} by

$${p}_{{\hat{y}}_{i}} ( u ) = {\prod }_{j = 1}^{v} {p}_{{\hat{y}}_{i , j}} ( {u}_{j} ) ,$$

where u∈R^{v} refers to any point in the v-dimensional space. We can refer p_{ŷ}_{ᵢ}: R^{v}→R as the v-dimensional PDF. To obtain the PMF on ŷᵢ point from the PDF, we need to integrate the PDF inside the grid which is located on ŷᵢ. It can be shown by P(ŷᵢ)=∫_{ŷ}_{ᵢ}_{+grid}p_{ŷ}_{ᵢ}(u)du again u∈R^{v} refers to any point in the v-dimensional space. These calculations can be done for all

$${\hat{y}}_{i} , i = 1 , … , m . m . \frac{o}{v} ,$$

thus, we will have

$$m . m . \frac{o}{v}$$

number of probability value P(ŷᵢ). The mentioned integral should be calculated analytically because we cannot do Monte Carlo simulations in the training phase. Thus, if there is no analytical solution of integral inside the grid, some approximations (simpler version of grid which has an analytical solution of integral) can be used. The expected bitlength can be found by the sum of negative log-likelihood by

$$- {\sum }_{i = 1}^{m . m . \frac{o}{v}} log ( P ( {\hat{y}}_{i} ) )$$

as our rate term in the loss function for main information.

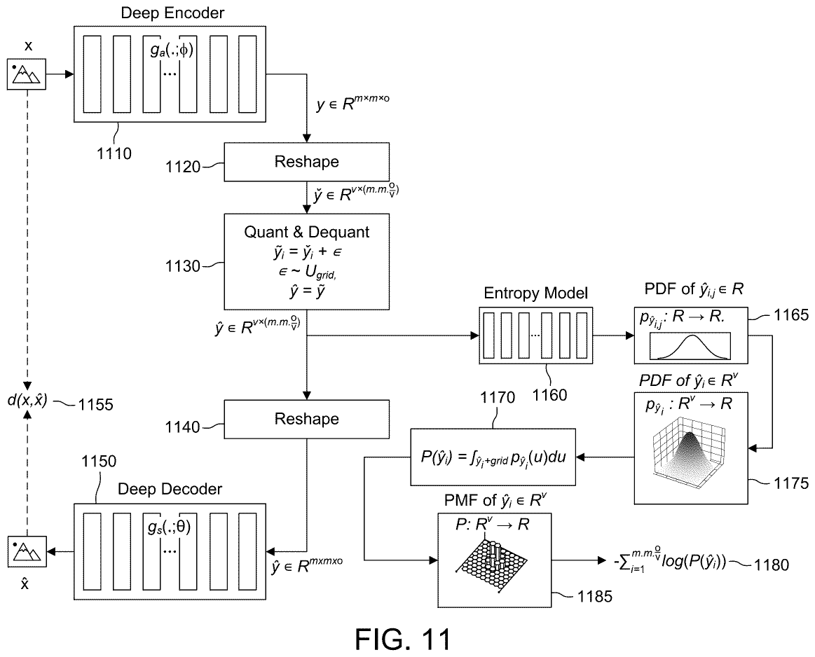

FIG. 11 illustrates the post-training loop of a full model for VQ grids, according to an embodiment.

### Forward Pass Steps for Full Model Post Training:

Step1. Input image x∈R^{n×n×3}, unit volume v-dimensional grid grid, and distribution U_{grid}.
Step2. Obtain embeddings y∈R^{m×m×o} by the deep encoder network (1110).
Step3. Reshape embeddings into pseudo v-dimensional embeddings

$$\check{y} ∈ {R}^{v \times ( m . m . \frac{o}{v} )}$$

(1120).
Step4. Apply continuous relaxation of grid as \tilde{y}ᵢ=y̌ᵢ+ϵ, ϵ~U_{grid}, ŷᵢ=\tilde{y}ᵢ, i=1, . . . ,

$${\tilde{y}}_{i} = {\check{y}}_{i} + ϵ , ϵ ∼ {U}_{grid} , {\hat{y}}_{i} = {\tilde{y}}_{i} , i = 1 , … , m . m . \frac{o}{v} ( 1130 ) .$$

Step5. Obtain (1165) the PDF of each scalar ŷ_{i,j}∈R of quantized latents p_{ŷ}_{_{i,j}}: R→R from the entropy model (1160).
Step6. Calculate the pseudo v-dimensional PDF (1175) by

$${p}_{{\hat{y}}_{i}} ( u ) = {\prod }_{j = 1}^{v} {p}_{{\hat{y}}_{i , j}} ( {u}_{i} )$$

(1170) where u∈R^{v}.
Step7. Calculate the PMF on ŷᵢ point for grid by P(ŷᵢ)=∫_{ŷ}_{ᵢ}_{+grid}p_{ŷ}_{ᵢ}(u)du (1185).
Step8. Calculate the rate term by the sum of negative log-likelihood

$$R = - {\sum }_{i = 1}^{m . m . \frac{o}{v}} log ( P ( {\hat{y}}_{i} ) )$$

(1180).
Step9. Reshape back

$$\hat{y} ∈ {R}^{v \times ( m . m . \frac{o}{v} )}$$

into ŷ∈R^{m×m×o} (1140).
Step10. Obtain the reconstructed image with the deep decoder network \hat{x}=gₛ(ŷ; θ) (1150).
Step11. Calculate the distortion term by D=d(x, \hat{x}) (1155).

The parameters of the full model can be finetuned by starting from pre-trained parameters as initial parameters by minimizing the following loss with tradeoff parameter λ in the default model.

$$Loss = {E}_{x ∼ D , ∈ ∼ {U}_{grid}} [ R + λ D ] .$$

The finetuned full model would give better performance than the first embodiment than the first embodiment alone and default model.

### Results

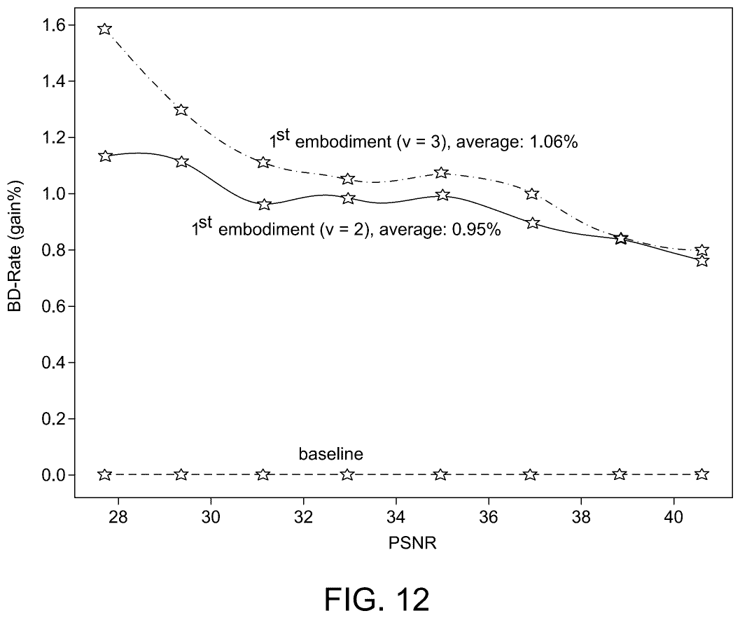

We used an already trained model in CompressAI library named mbt2018_mean proposed in an article by D. Minnen, et al., entitled “Joint autoregressive and hierarchical priors for learned image compression,” In Proceedings of the 32nd International Conference on Neural Information Processing Systems, pages 10794-10803, 2018. We implemented our first embodiment for 2D (hexagonal grid) and 3D (truncated octahedron grid) and showed the results in FIG. 12 over the Kodak test dataset for different models optimized for different rate-distortion tradeoffs. Our gains over quality are consistent. According to the results, the hexagonal grid can improve the performance more than 1% for lower quality, and on average 0.95%. With 3D VQ, we can improve the result more than 1.5% for lower quality, and more than 1% in general. These results are consistent with the theoretical background of VQ over SQ. The second embodiment on top of first one improves the average gain by up to 1.5% while the third embodiment on top of the first one gets 2% BD-rate gain which is significant in compression literature.

It should be noted that our methods are not limited to a specific neural network architecture, for example, the one shown in FIG. 5 know as a hyperprior model. Instead, our methods can be used in other neural network architectures, for example, fully factorized neural image/video model, implicit neural image/video compression model, recurrent network based neural image/video compression model or Generative Model based image/video compressing methods.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, and inverse transformation. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of video encoding, comprising:
obtaining latents associated with image data using a neural network;
performing uniform vector quantization on said latents to obtain respective codewords; and
performing lossless encoding on indices of said respective codewords based on a probability distribution of said latents.

2. (canceled)

3. The method of claim 1, wherein a codeword used to represent a partition region in said uniform vector quantization is fixed at a center of said partition region.

4. The method of claim 3, wherein a dimension of said partition region is encoded.

5. The method of claim 1, wherein said latents correspond to main information or side information.

6. The method of claim 1, wherein said latents are reshaped before said uniform vector quantization.

7. The method of claim 1, wherein parameters of said neural network are trained based on uniform scalar quantization.

8. The method of claim 7, wherein continuous relaxation of quantization is applied during said uniform scalar quantization.

9. (canceled)

10. A method of video decoding, comprising:
performing lossless decoding to obtain codeword indices based on a probability distribution of latents representing image data;
performing uniform vector de-quantization based on said codeword indices to reconstruct latents associated with said image data; and
decoding said image data from said reconstructed latents using a neural network.

11. (canceled)

12. The method of claim 10, wherein a codeword used to reconstruct a partition region in said uniform vector de-quantization is fixed at a center of said partition region.

13. The method of claim 12, wherein a dimension of said partition region is decoded.

14. The method of claim 10, wherein said latents correspond to main information or side information.

15. The method of claim 10, wherein codewords de-quantized from said uniform vector de-quantization are reshaped to obtain said reconstructed latents.

16-17. (canceled)

18. An apparatus, comprising one or more processors and at least one memory coupled to said one or more processors, wherein said one or more processors are configured to:
obtain latents associated with image data using a neural network;
perform uniform vector quantization on said latents to obtain respective codewords; and
perform lossless encoding on indices of said respective codewords based on a probability distribution of said latents.

19. The apparatus of claim 18, wherein a codeword used to represent a partition region in said uniform vector quantization is fixed at a center of said partition region.

20. The apparatus of claim 19, wherein a dimension of said partition region is encoded.

21. The apparatus of claim 18, wherein parameters of said neural network are trained based on uniform scalar quantization.

22. An apparatus, comprising one or more processors and at least one memory coupled to said one or more processors, wherein said one or more processors are configured to:
perform lossless decoding to obtain codeword indices based on a probability distribution of latents representing image data;
perform uniform vector de-quantization based on said codeword indices to reconstruct latents associated with said image data; and
decode said image data from said reconstructed latents using a neural network.

23. The apparatus of claim 22, wherein a codeword used to reconstruct a partition region in said uniform vector de-quantization is fixed at a center of said partition region.

24. The apparatus of claim 23, wherein a dimension of said partition region is decoded.

25. The apparatus of claim 22, wherein said latents correspond to main information or side information.
